(19) United States
(12) Patent Application Publication
(10) Pub. No.: US 2026/0350104 A1
(43) Pub. Date: Nov. 5, 2026

(54) TOPIC RECOMMENDATION METHOD AND APPARATUS, AND COMPUTER DEVICE AND STORAGE MEDIUM

(71) Applicant: BEIJING BYTEDANCE NETWORK TECHNOLOGY CO., LTD., Beijing (CN)

(72) Inventors: Xiaojie LI, Beijing (CN); Wenjing MENG, Beijing (CN); Rongchao HUANG, Beijing (CN)

(21) Appl. No.: 18/842,018

(22) PCT Filed: Mar. 23, 2023
(86) PCT No.: PCT/CN2023/083225

§ 371 Date: Jul. 20, 2026

(30) Foreign Application Priority Data
Apr. 28, 2022 (CN) 202210461489.7

(51) Int. Cl. G06F 16/9535

(52) U.S. Cl. CPC G06F 16/9535

(57) ABSTRACT

The present disclosure provides a topic recommendation method and apparatus, and a computer device and a storage medium. The method includes: in response to satisfying a recommended topic displaying condition, determining at least one topic to be recommended, the topic to be recommended comprising plurality of books; for the topic to be recommended, obtaining topic attribute information that is based on at least one dimension of the topic to be recommended as a recommendation reason matched with the topic to be recommended, wherein the dimension includes a topic dimension and/or a book dimension; and displaying the at least one topic to be recommended and the recommendation reason matched with the topic to be recommended.

### CROSS-REFERENCE TO RELATED APPLICATION(S)

The present disclosure claims priority to Chinese Patent Application No. 202210461489.7, entitled “TOPIC RECOMMENDATION METHOD AND APPARATUS, AND COMPUTER DEVICE AND STORAGE MEDIUM”, filed with the China National Intellectual Property Administration on Apr. 28, 2022, which is incorporated by reference in its entirety.

### FIELD

The present disclosure relates to the technical field of computers, and in particular, to topic recommendation method and apparatus, computer device and storage medium.

### BACKGROUND

In an electronic reading platform, recommended topics including books can be displayed to a user, so that the user can more quickly find books of interest according to discussions and recommendations on the books under the recommended topics.

Since a topic to be recommended itself presents relatively general or abstract content, it is usually difficult for a user to directly determine, through the topic to be recommended itself, whether the topic to be recommended contains books of interest. The user can only trigger each topic to be recommended in sequence to view detailed information of various topic posts under the topic to be recommended to make further judgments, resulting in low efficiency in searching for books of interest.

### SUMMARY

Embodiments of the present disclosure at least provide a topic recommendation method, apparatus, computer device and storage medium.

In a first aspect, the embodiments of the present disclosure provide a topic recommendation method, including: in response to satisfying a recommended topic displaying condition, determining at least one topic to be recommended, the topic to be recommended comprising a plurality of books; for the topic to be recommended, obtaining topic attribute information that is based on at least one dimension of the topic to be recommended as a recommendation reason matched with the topic to be recommended, wherein the dimension includes a topic dimension and/or a book dimension; and displaying the at least one topic to be recommended and the recommendation reason matched with the topic to be recommended.

In an optional implementation, the topic attribute information of the book dimension includes at least one of the following: book attribute information, wherein the book attribute information indicates whether the topic to be recommended includes a first target book, and the first target book is a book with corresponding read data satisfying a first condition; category attribute information, wherein the category attribute information is used for indicating whether the topic to be recommended includes a second target book that number of times of recommendation and/or a number of times of discussion under a target category meet a preset requirement; the target category is a book category with corresponding read data satisfying a second condition; the topic attribute information of the topic dimension includes consumption attribute information; the consumption attribute information is used for indicating a quantity of topic posts corresponding to the topic to be recommended and/or a number of converted readers; and the number of converted readers means a number of newly added users that have read the target book after the users read the topic to be recommended.

In an alternative implementation, the recommendation reason matched with the topic to be recommended is determined by the following mode: determining a recommendation reason template matched with the topic to be recommended from candidate recommendation reason templates respectively corresponding to the at least one dimension according to the topic attribute information of the topic to be recommended at the at least one dimension, wherein the recommendation reason template contains filling indication information and recommended word information; and extracting information matched with the filling indication information from the topic attribute information of the topic to be recommended to replace the filling indication information in the recommendation reason template to obtain the recommendation reason matched with the topic to be recommended.

In an alternative implementation, the method further includes: in response to recommendation reasons matched with the topic to be recommended including multiple, selecting a target recommendation reason from the plurality of recommendation reasons based on a priority sequence corresponding to the plurality of recommendation reasons; and using the target recommendation reason as the recommendation reason matched with the displayed topic to be recommended.

In an alternative implementation, the at least one topic to be recommended is determined by the following mode: determining the at least one topic to be recommended from a plurality of topics to be recommended based on a reading attribute feature and/or a topic hotness feature.

In an alternative implementation, before displaying the at least one topic to be recommended and the recommendation reason matched with the topic to be recommended, the method further includes: in a case that the topic attribution information of the topic to be recommended indicates that there is a target book, obtaining preview information of the target book; and displaying the at least one topic to be recommended and the recommendation reason matched with the topic to be recommended includes: displaying the at least one topic to be recommended, the recommendation reason matched with the topic to be recommended, and the preview information of the target book matched with the topic to be recommended.

In an alternative implementation, displaying the at least one topic to be recommended, the recommendation reason matched with the topic to be recommended, and the preview information of the target book matched with the topic to be recommended includes: displaying a plurality of topic cards in a topic recommendation region, wherein in each topic card, the topic to be recommended is displayed according to a first format; under the topic to be recommended, the recommendation reason matched with the topic to be recommended is displayed according to a second format; and in a case that there is the target book, the preview information is displayed according to a third format.

In a second aspect, the embodiments of the present disclosure further provide an apparatus for topic recommendation includes: a determining module, configured to: in response to satisfying a recommended topic displaying condition, determine at least one topic to be recommended, the topic to be recommended comprising plurality of books; an obtaining module, configured to for the topic to be recommended, obtain topic attribute information that is based on at least one dimension of the topic to be recommended as a recommendation reason matched with the topic to be recommended, wherein the dimension includes a topic dimension and/or a book dimension; and a display module, configured to display the at least one topic to be recommended and the recommendation reason matched with the topic to be recommended.

In an alternative implementation, the topic attribute information of the book dimension includes at least one of the following: book attribute information, wherein the book attribute information indicates whether the topic to be recommended includes a first target book, and the first target book is a book with corresponding read data satisfying a first condition; category attribute information, wherein the category attribute information is used for indicating whether the topic to be recommended includes a second target book that a number of times of recommendation and/or a number of times of discussion under a target category meets a preset requirement; the target category is a book category with corresponding read data satisfying a second condition; the topic attribute information of the topic dimension includes consumption attribute information; the consumption attribute information is used for indicating a quantity of topic posts corresponding to the topic to be recommended and/or a number of converted readers; and the number of converted readers means a number of newly added users that have read the target book after the users read the topic to be recommended.

In an alternative implementation, the apparatus for topic recommendation further includes a processing module; the recommendation reason matched with the topic to be recommended is determined by the processing module by the following mode: determining a recommendation reason template matched with the topic to be recommended from candidate recommendation reason templates respectively corresponding to the at least one dimension according to the topic attribute information of the topic to be recommended at the at least one dimension, wherein the recommendation reason template contains filling indication information and recommended word information; and extracting information matched with the filling indication information from the topic attribute information of the topic to be recommended to replace the filling indication information in the recommendation reason template to obtain the recommendation reason matched with the topic to be recommended.

In an alternative implementation, the processing module is further configured to in response to a plurality of recommendation reasons matched with the topic to be recommended including multiple, select a target recommendation reason from the plurality of recommendation reasons based on a priority sequence corresponding to the plurality of recommendation reasons; and use the target recommendation reason as the recommendation reason matched with the displayed topic to be recommended.

In an alternative implementation, the determining module determines the at least one topic to be recommended by the following mode: determining the at least one topic to be recommended from a plurality of topics to be recommended based on a reading attribute feature and/or a topic hotness feature.

In an alternative implementation, before displaying the at least one topic to be recommended and the recommendation reason matched with the topic to be recommended, the display module is further configured to: in a case that the topic attribution information of the topic to be recommended indicates that there is a target book, obtain preview information of the target book; and during displaying the at least one topic to be recommended and the recommendation reason matched with the topic to be recommended, the display module is configured to display the at least one topic to be recommended, the recommendation reason matched with the topic to be recommended, and the preview information of the target book matched with the topic to be recommended.

In an alternative implementation, during displaying the at least one topic to be recommended, the recommendation reason matched with the topic to be recommended, and the preview information of the target book matched with the topic to be recommended, the display module is configured to display a plurality of topic cards in a topic recommendation region, wherein in each topic card, the topic to be recommended is displayed according to a first format; under the topic to be recommended, the recommendation reason matched with the topic to be recommended is displayed according to a second format; and in a case that there is the target book, the preview information is displayed according to a third format.

In a third aspect, the embodiments of the present disclosure further provide a computer device, including a processor and a memory, wherein the memory stores machine-readable instructions executable by the processor; the processor is configured to execute the machine-readable instructions stored in the memory; and the machine-readable instructions, when executed by the processor, execute the steps in the first aspect or in any possible implementation in the first aspect.

In a fourth aspect, the embodiments of the present disclosure further provide a computer-readable storage medium, having a computer program stored thereon. The computer program, when run, executes the steps in the first aspect or in any possible implementation in the first aspect.

In a fifth aspect, the embodiments of the present disclosure further provide a computer program product. The computer program product carries program codes. Instructions included in the program codes are used for executing the steps in the first aspect or in any possible implementation in the first aspect.

According to the topic recommendation method and apparatus, and a computer device and a storage medium provided by the embodiments of the present disclosure, in a case that a topic to be recommended is determined, a recommendation reason matched under topic attribute information of at least one dimension of the topic to be recommended can be obtained, so that the recommendation reason matched under the topic to be recommended is displayed when the topic to be recommended is displayed. In this way, the topic to be recommended can be further described and explained in a targeted manner by using the displayed recommendation reason. A user can select a topic to be recommended of interest in a more targeted manner according to the recommendation reason, and then view book recommendation information under the topic to be recommended, thereby improving the efficiency of finding a book of interest.

To make the above objectives, features, and advantages of the embodiments of the present disclosure more apparent and understandable, the following text provides possible embodiments. A detailed explanation is made below in conjunction with the accompanying drawings.

### BRIEF DESCRIPTION OF THE DRAWINGS

To explain the technical solutions of the embodiments of the present disclosure more clearly, the drawings required to be used in the embodiments are briefly introduced below. The drawings here are incorporated into and form part of this specification. These drawings show the embodiments that comply with the present disclosure, and are used together with this specification to explain the technical solutions of the embodiments of the present disclosure. It should be understood that the accompanying drawings below only show some embodiments of the present disclosure. Therefore, the embodiments shall not be regarded as limitations on the scope. A person of ordinary skill in the art can also derive other relevant drawings according to these drawings without creative work.

FIG. 1 shows a flowchart of a method for topic recommendation provided by an embodiment of the present disclosure;

FIG. 2 shows a schematic diagram of a recommendation page that displays a topic to be recommended provided by an embodiment of the present disclosure;

FIG. 3 shows a schematic diagram of another recommendation page provided by an embodiment of the present disclosure;

FIG. 4 shows a schematic diagram of a topic recommendation apparatus provided by an embodiment of the present disclosure; and

FIG. 5 is a schematic diagram of a computer device provided by an embodiment of the present disclosure.

### DETAILED DESCRIPTION OF EMBODIMENTS

To make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all the embodiments of the present disclosure. Assemblies of the embodiments of the present disclosure commonly described and shown here may be arranged and designed in a variety of different configurations. Therefore, the following detailed descriptions of the embodiments of the present disclosure below are not intended to limit the scope of the claimed present disclosure, but merely represents selected embodiments of the present disclosure. All other embodiments obtained by a person skilled in the art based on the embodiments of the present disclosure without making creative efforts shall fall within the protection scope of the present disclosure.

Through research, it has been found that by displaying recommended topics including books to a user, the user can find a book of interest after viewing the recommended topics. Although a topic to be recommended may contain different discussion information of various books, during displaying of the topic to be recommended, title text of the topic to be recommended will be often directly displayed. Since the topic to be recommended itself presents relatively general or abstract content, it is usually difficult for a user to directly determine, through the topic to be recommended itself, whether the topic to be recommended contains books of interest. The user can only trigger each topic to be recommended in sequence to view detailed information of various topic posts under the topic to be recommended to make further judgments, resulting in low efficiency in searching for books of interest.

Based on the above research, the embodiments of the present disclosure provide a method for topic recommendation. In a case that a topic to be recommended is determined, a recommendation reason matched under topic attribute information of at least one dimension of the topic to be recommended can be obtained, so that the recommendation reason matched under the topic to be recommended is displayed when the topic to be recommended is displayed. In this way, the topic to be recommended can be further described and explained in a targeted manner by using the displayed recommendation reason. A user can select a topic to be recommended of interest in a more targeted manner according to the recommendation reason, and then view book recommendation information under the topic to be recommended, thereby improving the efficiency of finding a book of interest.

The defects in the above solutions are all found by the inventor by practice and careful research. Therefore, a finding process of the above problems and the following solutions provided by the embodiments of the present disclosure for the above problems should be contributions made by the inventor to the present disclosure in an implementing process of the embodiments of the present disclosure.

It should be noted that similar reference numerals and letters indicate similar items in the following drawings. Therefore, once a certain item is defined in one drawing, it is unnecessary to further define and explain it in the subsequent drawings.

For ease of understanding this embodiment, a topic recommendation method disclosed by an embodiment of the present disclosure is introduced in detail first. An executive body of the topic recommendation method provided by an embodiment of the present disclosure is generally a computer device with a computing ability. The computer device includes, for example, a terminal device or server or another processing device. The terminal device may be a User Equipment (UE), a mobile device, a user terminal, a terminal, a cellular phone, a cordless phone, a Personal Digital Assistant (PDA), a handheld device, a computing device, an in-vehicle device, and a wearable device. In some possible implementations, the topic recommendation method may be achieved by a processor by calling computer-readable instructions stored in a memory.

A user ends serving as the executive body is taken as an example below to explain the topic recommendation method provided by an embodiment of the present disclosure.

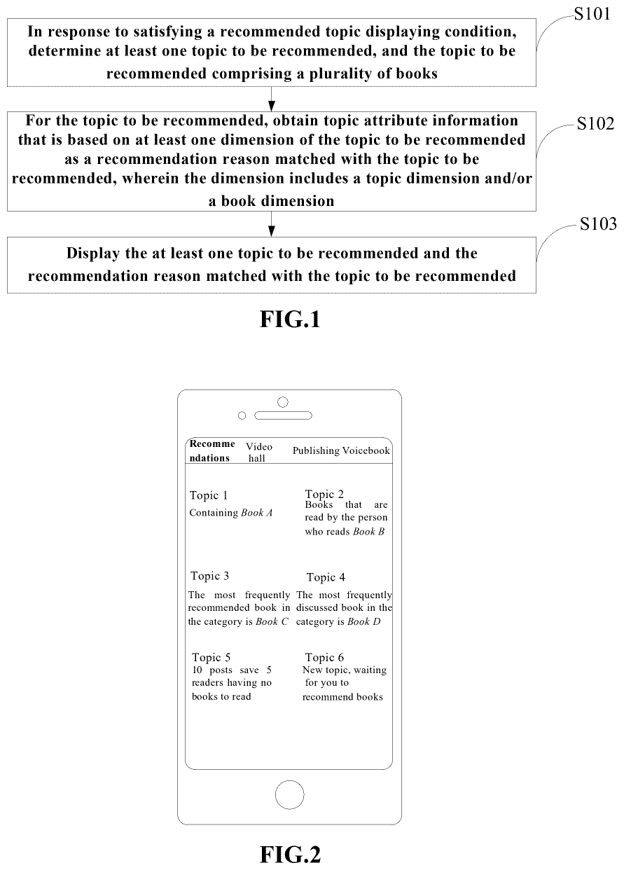

FIG. 1 shows a flowchart of a topic recommendation method provided by an embodiment of the present disclosure. The method includes step S101 to step S103.
S101: In response to satisfying a recommended topic displaying condition, at least one topic to be recommended is determined, and the topic to be recommended comprising plurality of books.
S102: For the topic to be recommended, topic attribute information that is based on at least one dimension of the topic to be recommended is obtained as a recommendation reason matched with the topic to be recommended, wherein the dimension includes a topic dimension and/or a book dimension.
S103: The at least one topic to be recommended and the recommendation reason matched with the topic to be recommended are displayed.
S101 to S103 described above will be explained in detail below.

For S101, the topic recommendation method provided by the embodiments of the present disclosure can be applied to different scenarios such as an electronic reading platform. The electronic reading platform is taken as an example. The electronic reading platform includes, for example, a recommendation page that displays topics to be recommended. FIG. 2 shows a schematic diagram of a recommendation page that displays a topic to be recommended provided by an embodiment of the present disclosure. The recommendation page specifically includes the displayed topic to be recommended and a recommendation reason matched with the topic to be recommended. In a possible situation, in response to a user opening the electronic reading platform, an information recommendation page is displayed. Alternatively, in response to a triggering operation performed on displaying of the recommendation page, at least one topic to be recommended that is to be displayed is displayed on the recommendation page.

A topic to be recommended is generally discussed around common attributes and characteristics of a type of books, so the topic to be recommended may include a plurality of books. In the topic to be recommended, a title or topic post of the topic to be recommended may contain book information such as the names of the books. For example, the topic to be recommended itself uses some books as a text title of the topic to be recommended. For example, the topic to be recommended is “Recommend Book A and Book B written by author J”. In this case, a plurality of books may be determined based on the topic to be recommended itself, such as including Book A and Book B in the above example.

In another possible situation, as the topic to be recommended further specifically includes topic posts. The topic posts are created around the topic to be recommended, so that different users can make comments for communication on books related to the topic to be recommended. Exemplarily, if the topic to be recommended is “the most worthwhile science fiction to read”, a specific book cannot be determined based on the topic to be recommended. However, under the topic to be recommended, a user can participate in discussion in a topic post, such as generating a topic post of “recommend Science Fiction C”, or make a comment under a topic post, such as “I recommend Science Fiction D”. Correspondingly, a plurality of books, such as Science Fiction C and Science Fiction D described above, included in the topic to be recommended can be determined from the topic posts and comment messages of the topic posts.

In addition, in addition to displaying the books included in the topic to be recommended in a textual form, covers of the books, reading pages of the books, read links of the books, and the like can be displayed in the topic to be recommended and/or the topic posts under the topic to be recommended. The specific details can be determined based on an actual situation, and will not be elaborated here.

In a specific implementation, the at least one topic to be recommended for displaying may be determined by specifically using the following mode: determining the at least one topic to be recommended from a plurality of topics to be recommended based on a reading attribute feature and/or a topic hotness feature.

The reading attribute feature indicates a preference of a user during reading, specifically including, for example, classes of books that the user likes, such as liking to read ancient books or modern literatures; a reading habit of the user during reading of books, such as preferring to fast reading or slow reading; and a preference of the user during browsing of topics, such as preferring to revealing discussion or non-revealing discussion. The topic hotness feature may be determined according to a number of times of view of the topic to be recommended. The number of times of view indicates a total number of times that the topic to be recommended has been viewed.

In one possible situation, a plurality of created topics to be recommended can be obtained from the electronic reading platform. The created topics to be recommended that can be obtained may be created by a user on the platform or created by the platform. When the at least one topic to be recommended is determined from the plurality of topics to be recommended by using the reading attribute feature, a user can be provided in a more targeted manner with more appropriate topics according to a reading preference feature of the user. When the at least one topic to be recommended is determined from the plurality of topics to be recommended by using the topic hotness feature, a user can be provided with hot topics to be recommended that have higher instantaneity for displaying.

For S102 above, regarding the at least one topic to be recommended determined in S101, to further make a targeted description and explanation to the topic to be recommended to enable a user to more easily select and view the at least one topic to be recommended from the displayed topics to be recommended according to a recommendation reason, topic attribute information that is based on at least one dimension of the topic to be recommended is obtained as a recommendation reason matched with the topic to be recommended, wherein the dimension includes a topic dimension and/or a book dimension. Specifically, the topic attribute information of the book dimension includes at least one of the following: book attribute information and category attribute information. The topic attribute information of the topic dimension includes consumption attribute information.

The above three different kinds of topic attribute information will be introduced below.

(a) Book attribute information.

The book attribute information is used for indicating whether the topic to be recommended includes a first target book, and the first target book is a book with corresponding read data satisfying a first condition. A plurality of books that have been read by a user and read data respectively corresponding to the plurality of books can be determined according to historical read data of the user obtained by authorization of the user. The first target book can be determined from the plurality of books according to whether the read data respectively corresponding to the plurality of books that have been read by the user satisfy the first condition.

When the first target book is determined according to the first condition, in a possible situation, the first condition may include: If the read data of the user on the books within a period of time indicates that a current number of chapters that have been read exceeds a preset number of chapters, for example, if the user has read more than 10 chapters in the past 30 days, a book with over 10 chapters that have been read in the past 30 days is used as the first target book according to the historical read data of the user obtained by the authorization of the user. In another possible situation, the first condition may further include: The historical read data of the user obtained by the authorization of the user indicates that a current number of chapters that have been read of a book exceeds a preset number of chapters. If there is another user who is of the same type as the user (for example, users with the same reading attribute feature are regarded as users of the same type), and historical read data obtained by authorization of the another user indicates that the another user also has read this book, another book that has been read by the user and is indicated in the historical read data of the another user of the same type is used as the first target book. According to the above explanation, it can be seen that in the two different situations, the modes for obtaining the first target book included in the topic to be recommended are different.

In this case, the book attribute information of the topic to be recommended can be determined by determining whether the topic to be recommended includes the first target book. The topic to be recommended includes the first target book, which can specifically include mentioning and recommending the first target book under the topic to be recommended.

Exemplarily, for a topic to be recommended, if the topic to be recommended includes the first target book with over 10 chapters that have been read by the user in the past 30 days, the book attribute information corresponding to the topic to be recommended indicates that the topic to be recommended includes the first target book. Alternatively, if the topic to be recommended includes the first target book with over 10 chapters that have been read by the another user who is of the same type of the user in the past 30 days, the book attribute information corresponding to the topic to be recommended indicates that the topic to be recommended includes the first target book.

(b) Category attribute information.

The category attribute information is used for indicating whether the topic to be recommended includes a second target book that number of times of recommendation and/or a number of times of discussion under a target category meets a preset requirement; the target category is a book category with corresponding read data satisfying a second condition. A category refers to classification of books. A specific classification mode can be determined according to an actual situation, such as classifying books into science fictions, romantic fictions, historical masterpieces, and the like.

When the target category is determined according to the read data satisfying the second condition, a category to which frequently read books belong can be determined, according to the historical read data obtained by authorization of a user, as the target category from books that have been read by the user within a period of time. Exemplarily, the top three popular books in the past 30 days can be determined according to the historical read data obtained by authorization of a user, and a category to which these books belong can be determined as the target category.

In this case, the category attribute information of the topic to be recommended can be determined by determining whether the topic to be recommended includes a book under the target category, a number of times of recommendation of the book meeting a preset requirement. In a case that the target category is determined, a plurality of books in the target category can be determined. During the determination of the second target book that meets the preset requirement, the preset requirement can include, for example, a maximum number of times of recommendation or discussion.

Exemplarily, for a topic to be recommended, if the topic to be recommended includes a book with a maximum number of times of recommendation and/or discussion under the target category to which the top three books that have been frequently read by a user in the past 30 days, it can be determined that the category attribute information corresponding to the topic to be recommended indicates that the topic to be recommended includes a second target book that number of times of recommendation and/or a number of times of discussion under a target category meets a preset requirement.

(c) Consumption attribute information.

The consumption attribute information is used for indicating a quantity of topic posts corresponding to the topic to be recommended and/or a number of converted readers; and the number of converted readers refers to a number of newly added users that have read the target book after the users read the topic to be recommended.

The topic to be recommended specifically further includes topic posts. The topic posts are webpages that are created around the topic to be recommended for users to communicate with each other about books. A quantity of the topic posts corresponding to the topic to be recommended is a statistical quantity of the topic posts under the topic to be recommended. The topic posts under the topic to be recommended can include discussions and recommendations about books. These books are used as target books in this mode. Since a user may further read these books after viewing the topic to be recommended, after users read the topic to be recommended, a number of users who start to read the target books contained in the topic to be recommended can be determined as the number of converted readers corresponding to the topic to be recommended.

Exemplarily, for a topic to be recommended, it can be determined that the corresponding consumption attribute information indicates that the quantity of topic posts is 10; or, the consumption attribute information indicates that the number of converted readers is 3. Generally, when there are a large number of topic posts under the topic to be recommended, the number of converted readers will increase. Therefore, to make the recommendation reason under the topic to be recommended better, it is possible to determine the corresponding consumption attribute information for the topic to be recommended when the quantity of topic posts reaches a certain number. For example, when the quantity of topic posts under the topic to be recommended exceeds 5, the corresponding consumption attribute information can be determined for the topic to be recommended.

For the topic to be recommended, the matched recommendation reason may be determined according to the topic attribute information of the at least one dimension of the topic to be recommended. In a specific implementation, it is possible to determine a recommendation reason template matched with the topic to be recommended from candidate recommendation reason templates respectively corresponding to the at least one dimension according to the topic attribute information of the topic to be recommended at the at least one dimension, wherein the recommendation reason template contains filling indication information and recommended word information; and extract information matched with the filling indication information from the topic attribute information of the topic to be recommended, and replace the filling indication information in the recommendation reason template to obtain the recommendation reason matched with the topic to be recommended.

The topic attribute information under different dimensions explained above is taken as an example to exemplify determining the recommendation reason matched with the topic to be recommended.

For the (a) book attribute information above, specifically indicating whether the recommended topic includes a first target book, there are possible situations:

(a1) The first target book is a book that has been read by the user.

In this case, the recommendation reason template selected from the candidate recommendation reason templates is, for example, “containing #filling the title of the first target book#”. “Containing” is the recommended word information, and “#filling the title of the first target book#” is the filling indication information. If the filling indication information indicates filling the title of the first target book in this situation, the title of the first target book can be extracted according to the topic attribute information of the topic to be recommended, and a position corresponding to the filling indication information of the recommendation reason template can be replaced.

Exemplarily, if it is determined that the topic to be recommended is “Topic 1”, and the book attribute information of the topic to be recommended indicates that there is a first target book that has been read by the user and the first target book is book A, it can be determined according to the recommendation reason template listed in the above example that the recommendation reason matched with the topic to be recommended, namely “Topic 1”, is 1:“containing Book A”.

(a2) The first target book is a book that has been read by another user who is of the same type as the user.

Exemplarily, in this case, the first target book is book A, and a book that has been read by both the user and a user who is of the same type is book B. The recommendation reason template determined from the candidate recommendation reason templates is, for example, “Books that are read by the person who reads #filling the title of Book B#”. “Books that are read by the person who reads XXX” is the recommended word information, and “#filling the title of book B#” is the filling indication information. Unlike situation (al) above, during the determination of the recommendation reason of the topic, the first target book is not extracted for replacement. This is because the topic to be recommended is actually intended to help provide a user with books that have been read by users of the same type.

Therefore, exemplarily, if it is determined that the topic to be recommended is “Topic 2”, the book attribute information of the topic to be recommended indicates that there is a first target book that has been read by another user of the same type as the user, and the book filled by the user is book B, it can be determined that the recommendation reason matched with the topic to be recommended, namely “Topic 2”, is 2:“Books that are read by the person who reads Book B”.

For the (b) category attribute information above, specifically indicating whether the topic to be recommended includes a second target book that a number of times of recommendation and/or a number of times of discussion under a target category meets a preset requirement, there are possible situations:

(b1) The category attribute information indicates that the topic to be recommended includes a second target book that number of times of recommendation under a target category meets a preset requirement.

In this case, the recommendation reason template selected from the candidate recommendation reason templates is, for example, “the most frequently recommended book in the category #filling the title of the second target book#”. “The most frequently recommended book in the category” is the recommended word information, and “#filling the title of the second target book#” is the filling indication information. If the filling indication information indicates filling the title of the second target book in this situation, the title of the second target book can be extracted according to the category attribute information of the topic to be recommended, and a position corresponding to the filling indication information of the recommendation reason template can be replaced.

Exemplarily, if it is determined that the topic to be recommended is “Topic 3”, and the corresponding category attribute information indicates that the topic to be recommended includes the second target book under the target category, and the number of times of recommendation of the second target book meets the preset requirement, and the second target book is book C, it can be determined according to the recommendation reason template listed in the above example that the recommendation reason matched with the topic to be recommended, namely “Topic 3”, is 3:“The most frequently recommended book in the category is Book C”.

(b2) The category attribute information indicates that the topic to be recommended includes a second target book that a number of times of discussion under a target category meets a preset requirement.

In this case, the recommendation reason template selected from the candidate recommendation reason templates is, for example, “the most frequently discussed book in the category #filling the title of the second target book#”. “The most frequently discussed book in the category” is the recommended word information, and “#filling the title of the second target book#” is the filling indication information. If the filling indication information indicates filling the title of the second target book in this situation, the title of the second target book can be extracted according to the category attribute information of the topic to be recommended, and a position corresponding to the filling indication information of the recommendation reason template can be replaced.

Exemplarily, if it is determined that the topic to be recommended is “Topic 4”, and the corresponding category attribute information indicates that the topic to be recommended includes the second target book under the target category, and the number of times of discussion of the second target book meets the preset requirement, and the second target book is book D, it can be determined according to the recommendation reason template listed in the above example that the recommendation reason matched with the topic to be recommended, namely “Topic 4”, is 4:“The most frequently recommended book in the category is Book D”.

For the (c) consumption attribute information above, specifically indicating a quantity of topic posts and/or a number of converted readers corresponding to the topic to be recommended, in this case, the recommendation reason template determined from the candidate recommendation reason templates is, for example, “#filling the quantity of topic posts# posts save #filling the number of converted readers# readers having no books to read”. “XX posts save XX readers having no books to read” is the recommended word information, “#filling the number of topic posts#” and “#filling the number of converted readers#” are the filling indication information. If the filling indication information indicates filling the number of topic posts and the number of converted readers indicated in the consumption attribute information in this situation, the quantity of topic posts and the number of converted readers can be obtained correspondingly according to the consumption attribute information of the topic to be recommended, and a position corresponding to the filling indication information of the recommendation reason template can be replaced.

For example, if it is determined that the topic to be recommended is “Topic 5”, and the corresponding consumption attribute information indicates that the quantity of topic posts corresponding to the topic to be determined as is 10 and the number of converted readers is 5, it can be then determined according to the recommendation reason template listed in the above example that the recommended reason matched with the topic to be recommended, namely “Topic 5”, is 5:“10 posts save 5 readers having no books to read”.

In addition, the topic to be recommended may not be matched with any of the topic attribute information listed above. For example, the quantity of topic posts in the topic to be recommended is small, for example, the quantity of topic posts in the topic to be recommended does not exceed 5, and the topic to be recommended does not include the target book described in (a) or books under the target category described in (b), and does not have the condition to determine the consumption attribute information. In this case, for example, it can be determined that the recommendation reason matched with the topic to be recommended is “New topic, waiting for you to recommend books”.

Exemplarily, if it is determined that the topic to be recommended is “Topic 6”, and the quantity of topic posts under Topic 6 is less than 5 and the above conditions are satisfied, it can be determined that the recommendation reason matched with the topic to be recommended, namely “Topic 6”, is 6:“New topic, waiting for you to recommend books”.

In a possible situation, for any topic to be recommended, such as “Topic 1” to “Topic 6” mentioned above, there may be topic attribute information in different dimensions, so there may be a plurality of recommendation reasons that can be matched under different pieces of topic attribute information. To display the recommendation reasons of the topic to be recommended more concisely and clearly, one of the recommendation reasons can be selected for displaying.

In a specific implementation, in response to recommendation reasons matched with the topic to be recommended including multiple, a target recommendation reason is selected from the plurality of recommendation reasons based on a priority sequence corresponding to the plurality of recommendation reasons; and the target recommendation reason is used as the recommendation reason matched with the displayed topic to be recommended.

The priority sequence can be predetermined, for example, a sequence of determining the recommendation reasons 1 to 6 as described above is determined as the priority sequence. In the above recommendation reasons 1 to 6, recommendation reasons with high priorities are determined according to historically read books determined according to the historical read data obtained by the authorization of the user, so that the recommendation reasons are more in line with an actual reading demand of the user. Recommendation reasons with low priorities are determined according to reading situations of more users. Therefore, the user can be promoted to view more popular topics through the recommendation reasons.

For S103 above, after being determined, the topic to be recommended and the matched recommendation reason can be displayed.

In a possible situation, if the topic attribute information of the topic to be recommended indicates that there is a target book, preview information of the target book can be obtained, and the at least one topic to be recommended, the recommendation reason matched with the topic to be recommended, and the preview information of the target book matched with the topic to be recommended can be displayed.

Specifically, during displaying the at least one topic to be recommended, the recommendation reason, and the preview information of the target book, a plurality of topic cards can be displayed in a topic recommendation region, wherein in each topic card, the topic to be recommended is displayed according to a first format; under the topic to be recommended, the recommendation reason matched with the topic to be recommended is displayed according to a second format; and in a case that there is the target book, the preview information is displayed according to a third format.

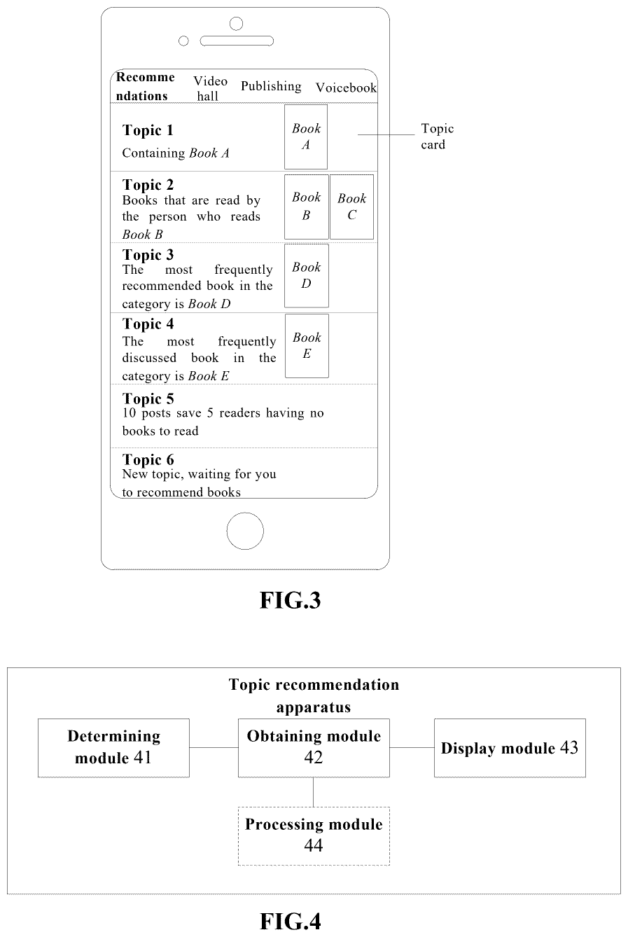

Exemplarily, during displaying of the topic to be recommended, the recommendation reason, and the preview information of the target book, FIG. 3 shows a schematic diagram of another recommendation page provided by an embodiment of the present disclosure. FIG. 3 specifically shows that a plurality of topics to be recommended, recommendation reasons matched with the topics to be recommended, and preview information displayed for target books are displayed in the form of topic cards. There may be one or more target books, so during the displaying of the preview information, the preview information respectively corresponding to one or more target books can be displayed.

To highlight a difference between a topic to be recommended and a recommendation reason, the first format used for displaying the topic to be recommended is, for example, a large font format, and the second format used for displaying the recommendation reason is, for example, a small font format. In addition, further distinguishing can be achieved through bold and underlining or by annotation using a symbol such as “#”. In a case that there is either a first target book or a second target book in the recommendation reason, the preview information of the target book can also be displayed in the third format, such as a cover image of the target book.

In this way, the displayed information can be clearly prioritized by displaying different information in different formats, making it easier for distinguishing and reading. In addition, in a possible situation, the displayed preview information can be triggered and jumps to a reading page of the target book, making it easier for a user to directly read the target book.

A person skilled in the art can understand that in the methods mentioned above of the specific implementations, the writing order of the respective step does not imply a strict execution order and imposes any restrictions on the implementation process. The specific execution order of the respective steps should be determined on the basis of functions and possible internal logics of the steps.

Based on the same inventive concept, the embodiments of the present disclosure further provide a topic recommendation apparatus corresponding to the topic recommendation method. Since the principle of the apparatus in the embodiments of the present disclosure for solving the problem is like the topic recommendation method described above in the embodiments of the present disclosure, the implementation of the apparatus can refer to the implementation of the method, and any repetition will be avoided.

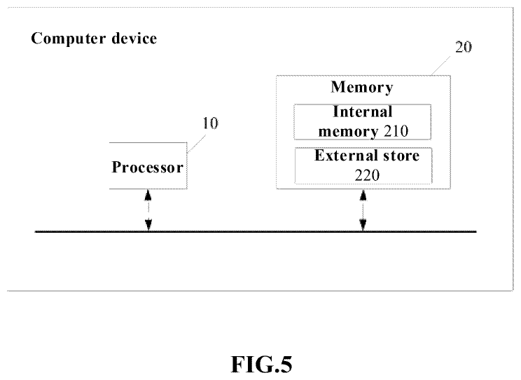

FIG. 4 shows a schematic diagram of a topic recommendation apparatus provided by an embodiment of the present disclosure. The apparatus includes a determining module 41, an obtaining module 42, and a display module 43.

The determining module 41 is configured to: in response to satisfying a recommended topic displaying condition, determine at least one topic to be recommended, and the topic to be recommended comprising plurality of books;

the obtaining module 42 is configured to for the topic to be recommended, obtain topic attribute information that is based on at least one dimension of the topic to be recommended as a recommendation reason matched with the topic to be recommended, wherein the dimension includes a topic dimension and/or a book dimension; and the display module 43 is configured to display the at least one topic to be recommended and the recommendation reason matched with the topic to be recommended.

In an alternative implementation, the topic attribute information of the book dimension includes at least one of the following: book attribute information, wherein the book attribute information indicates whether the topic to be recommended includes a first target book, and the first target book is a book with corresponding read data satisfying a first condition; category attribute information, wherein the category attribute information is used for indicating whether the topic to be recommended includes a second target book that number of times of recommendation and/or a number of times of discussion under a target category meets a preset requirement; the target category is a book category with corresponding read data satisfying a second condition; the topic attribute information of the topic dimension includes consumption attribute information; the consumption attribute information is used for indicating a quantity of topic posts corresponding to the topic to be recommended and/or a number of converted readers; and the number of converted readers means a number of newly added users that have read the target book after the users read the topic to be recommended.

In an alternative implementation, the topic recommendation apparatus further includes a processing module 44; the recommendation reason matched with the topic to be recommended is determined by the processing module 44 by the following mode: determining a recommendation reason template matched with the topic to be recommended from candidate recommendation reason templates respectively corresponding to the at least one dimension according to the topic attribute information of the topic to be recommended at the at least one dimension, wherein the recommendation reason template contains filling indication information and recommended word information; and extracting information matched with the filling indication information from the topic attribute information of the topic to be recommended, and replacing the filling indication information in the recommendation reason template to obtain the recommendation reason matched with the topic to be recommended.

In an alternative implementation, the processing module 44 is further configured to in response to recommendation reasons matched with the topic to be recommended including multiple, select a target recommendation reason from the plurality of recommendation reasons based on a priority sequence corresponding to the plurality of recommendation reasons; and use the target recommendation reason as the recommendation reason matched with the displayed topic to be recommended.

In an alternative implementation, the determining module 41 determines the at least one topic to be recommended by the following mode: determining the at least one topic to be recommended from a plurality of topics to be recommended based on a reading attribute feature and/or a topic hotness feature.

In an alternative implementation, before the displaying the at least one topic to be recommended and the recommendation reason matched with the topic to be recommended, the display module 43 is further configured to: in a case that the topic attribution information of the topic to be recommended indicates that there is a target book, obtain preview information of the target book; and during the displaying the at least one topic to be recommended and the recommendation reason matched with the topic to be recommended, the display module 43 is configured to display the at least one topic to be recommended, the recommendation reason matched with the topic to be recommended, and the preview information of the target book matched with the topic to be recommended.

In an alternative implementation, during displaying the at least one topic to be recommended, the recommendation reason matched with the topic to be recommended, and the preview information of the target book matched with the topic to be recommended, the display module 43 is configured to display a plurality of topic cards in a topic recommendation region, wherein in each topic card, the topic to be recommended is displayed according to a first format; under the topic to be recommended, the recommendation reason matched with the topic to be recommended is displayed according to a second format; and in a case that there is the target book, the preview information is displayed according to a third format.

The descriptions of the processing flows of the respective modules in the apparatus and the descriptions of the interaction flows between the modules can refer to the relevant explanations in the above method embodiments, and will not be detailed here.

The embodiments of the present disclosure further provide a computer device. FIG. 5 shows a schematic structural diagram of a computer device provided by an embodiment of the present disclosure. The computer device includes:

a processor 10 and a memory 20. The memory 20 stores machine-readable instructions that are executable by the processor 10; the processor 10 is configured to execute the machine-readable instructions stored in the memory 20; and when the machine-readable instructions are executed by the processor 10, the processor 10 executes the following steps:

in response to satisfying a recommended topic displaying condition, determining at least one topic to be recommended, and the topic to be recommended comprising plurality of books; for the topic to be recommended, obtaining topic attribute information that is based on at least one dimension of the topic to be recommended as a recommendation reason matched with the topic to be recommended, wherein the dimension includes a topic dimension and/or a book dimension; and displaying the at least one topic to be recommended and the recommendation reason matched with the topic to be recommended.

The memory 20 includes an internal memory 210 and an external memory 220. The internal memory 210, also referred to as an internal memory, is configured to temporarily store operational data in the processor 10 and data exchanged with the external memory 220 such as a hard disk drive. The processor 10 exchanges data with the external memory 220 through the internal memory 210.

The specific execution process of the above instructions may be found in the steps of the topic recommendation method in the embodiments of the present disclosure, and will not be elaborated here.

The embodiments of the present disclosure further provide a computer-readable storage medium, having a computer program stored thereon. The computer program, when run by a processor, execute the steps of the topic recommendation method in the above method embodiments. The storage medium may be a volatile or a non-volatile computer-readable storage medium.

The embodiments of the present disclosure further provide a computer program product. The computer product carries program codes, and instructions included in the program codes can be used for executing the steps of the topic recommendation method in the above method embodiments. Specific details can refer to the method embodiments described above, and will not be repeated here.

The above computer program product can be specifically implemented through hardware, software, or a combination of hardware and software. In an alternative embodiment, the computer program product is specifically embodied as a computer storage medium, while in another alternative embodiment, the computer program product is specifically embodied as a software product, such as a Software Development Kit (SDK).

A person skilled in the art can clearly understand that for the convenience and conciseness of the description, specific working processes of the system and apparatus described above can refer to the corresponding processes in the above method embodiments, and will not be described in detail here. In the several embodiments provided by the present disclosure, it should be understood that the disclosed system, apparatus, and method are achieved in other manners. The above-described apparatus embodiments are merely illustrative. For example, the division of the units is only one type of logical functional division, and other divisions is achieved in practice. For another example, multiple units or components can be combined or integrated into another system, or some features can be omitted, or not executed. In addition, the shown or discussed mutual coupling or direct coupling or communication connection is an indirect coupling or communication connection through some communication interfaces, apparatuses, or units, and is in an electrical, mechanical or another form.

The units described as separate parts may or may not be physically separate, and parts displayed as units may or may not be physical units, may be in one position, or may be distributed on a plurality of network units. Some of or all the units are selected according to actual needs to achieve the objective of the solution of this embodiment.

In addition, the functional units in various embodiments of the present disclosure may be integrated in a single processing unit. The units may exist physically separately, or two or more units may be integrated in one unit.

When the functions are implemented in the form of software functional units and sold or used as independent products, the functions may be stored in a non-volatile computer-readable storage medium executable by a processor. Based on such an understanding, the technical solutions of the present disclosure essentially, or the part contributing to the prior art, or some of the technical solutions may be presented in the form of a software product. The computer software product is stored in a storage medium, and includes several instructions for instructing a computer device (which may be a personal computer, a server, a network device, or the like) to perform all or some of the steps of the methods of the various embodiments of the present disclosure. The aforementioned storage media include: various media that can store program codes, such as a USB flash drive, a mobile hard disk drive, a Read-Only Memory (ROM), a Random Access Memory (RAM), a magnetic disk, and a compact disc.

It should be finally noted that the above embodiments are only specific embodiments of the present disclosure and are intended to explain the technical solutions of the present disclosure, rather than limiting them. The protection scope of the present disclosure is not limited to this. Although detailed explanations have been made to the present disclosure by referring to the aforementioned embodiments, a person of ordinary skill in the art should understand that any person skilled in the art can still modify the technical solutions recorded in the aforementioned embodiments or easily think of changes within the scope disclosed by the present disclosure, or equivalently replace some of the technical features. These modifications, changes, or replacements do not separate the essences of the corresponding technical solutions from the spirit and scope of the embodiments of the present disclosure, and should fall within the protection scope of the present disclosure. Therefore, the protection scope of the present disclosure shall be subject to the claims.

I/We claim:

1. A method for topic recommendation, comprising:
in response to satisfying a recommended topic displaying condition, determining at least one topic to be recommended, the topic to be recommended comprising a plurality of books;
for the topic to be recommended, obtaining topic attribute information that is based on at least one dimension of the topic to be recommended as a recommendation reason matched with the topic to be recommended; wherein the dimension comprises a topic dimension and/or a book dimension; and
displaying the at least one topic to be recommended and the recommendation reason matched with the topic to be recommended.

2. The method of claim 1, wherein the topic attribute information of the book dimension comprises at least one of the following:
book attribute information, wherein the book attribute information indicates whether the topic to be recommended comprises a first target book, and the first target book is a book with corresponding read data satisfying a first condition;
category attribute information, wherein the category attribute information is used for indicating whether the topic to be recommended comprises a second target book that number of times of recommendation and/or number of times of discussion under a target category meets a preset requirement, the target category is a book category with corresponding read data satisfying a second condition;
the topic attribute information of the topic dimension comprises consumption attribute information; the consumption attribute information is used for indicating a quantity of topic posts corresponding to the topic to be recommended and/or a number of converted readers, and the number of converted readers means a number of newly added users that have read the target book after the users read the topic to be recommended.

3. The method of claim 1 or 2, wherein the recommendation reason matched with the topic to be recommended is determined by the following mode:
determining a recommendation reason template matched with the topic to be recommended from candidate recommendation reason templates respectively corresponding to the at least one dimension according to the topic attribute information of the topic to be recommended in the at least one dimension, wherein the recommendation reason template contains filling indication information and recommended word information; and
extracting information matched with the filling indication information from the topic attribute information of the topic to be recommended to replace the filling indication information in the recommendation reason template to obtain the recommendation reason matched with the topic to be recommended.

4. The method of claim 3, further comprising:
in response to recommendation reasons matched with the topic to be recommended including multiple, selecting a target recommendation reason from the plurality of recommendation reasons based on a priority sequence corresponding to the plurality of recommendation reasons; and
using the target recommendation reason as the recommendation reason matched with the displayed topic to be recommended.

5. The method of claim 1, wherein the at least one topic to be recommended is determined by the following mode:
determining the at least one topic to be recommended from a plurality of topics to be recommended based on a reading attribute feature and/or a topic hotness feature.

6. The method of claim 1, wherein before displaying the at least one topic to be recommended and the recommendation reason matched with each topic to be recommended, further comprises:
in a case that the topic attribution information of the topic to be recommended indicates that there is a target book, obtaining preview information of the target book; and
displaying the at least one topic to be recommended and the recommendation reason matched with the topic to be recommended comprises:
displaying the at least one topic to be recommended, the recommendation reason matched with the topic to be recommended, and the preview information of the target book matched with the topic to be recommended.

7. The method of claim 6, wherein displaying the at least one topic to be recommended, the recommendation reason matched with the topic to be recommended, and the preview information of the target book matched with the topic to be recommended comprises:
displaying a plurality of topic cards in a topic recommendation region,
wherein in each topic card, the topic to be recommended is displayed according to a first format; under the topic to be recommended, the recommendation reason matched with the topic to be recommended is displayed according to a second format; and in a case that there is the target book, the preview information is displayed according to a third format.

8. An apparatus for topic recommendation, comprising:
a determining module, configured to in response to satisfying a recommended topic displaying condition, determine at least one topic to be recommended, the topic to be recommended comprising a plurality of books;
an obtaining module, configured to for the topic to be recommended, obtain topic attribute information that is based on at least one dimension of the topic to be recommended as a recommendation reason matched with the topic to be recommended, wherein the dimension comprises a topic dimension and/or a book dimension; and
a displaying module, configured to display the at least one topic to be recommended and the recommendation reason matched with the topic to be recommended.

9. A computer device, comprising: a processor and a memory, wherein the memory stores machine-readable instructions that are executable by the processor; the processor is configured to execute the machine-readable instructions stored in the memory; and when the machine-readable instructions are executed by the processor, the processor executes the steps of the topic recommendation method according to any one of claims 1 to 7.

10. A computer-readable storage medium, having a computer program stored thereon, wherein when the computer program is run by a computer device, the computer device executes the steps of the topic recommendation method according to any one of claims 1 to 7.

11. A computer program product, wherein the computer program product carries program codes; and instructions comprised in the program codes are used for executing the steps of the topic recommendation method according to any one of claims 1 to 7.
